(19) United States
(12) Patent Application Publication
(10) Pub. No.: US 2009/0278410 A1
(43) Pub. Date: Nov. 12, 2009

(54) Pre-Set Timer and Plug Adapter

(76) Inventor: Michael Robert Ayers, Belmar, NJ (US)

Correspondence Address: Michael R. Ayers, 115 6th Ave., Belmar, NJ, 07719, US

(21) Appl. No.: 12/454,114

(22) Filed: Aug. 13, 2008

Related U.S. Application Data
(60) Provisional application No. 61/050,728, filed on May 6, 2008.

(51) Int. Cl. H01H 43/04

(52) U.S. Cl. 307/141.4; 327/518

(57) ABSTRACT

A plug adapter in combination with a pre-set digital timer (in minutes) that plugs into an electrical wall outlet and safely disconnects the current to any device plugged into the adapter after a pre-set time period has elapsed. The pre-set timer and plug adapter includes an on-off push button switch and a selector button to choose a shorter time period as desired.

This Non-provisional Application claims priority over Provisional Application No. 61/050,728 submitted on 6 May 2008.

### BACKGROUND OF THE INVENTION

The objective of this invention is to provide an improved plug adapter that safely turns off a household appliance or electrical device after a specific time period has elapsed. The timer provides a safety feature which prevents over-heating or over-charging of appliances and tools left unattended or which have been inadvertently left in the ‘on’ position. The adapter also has the added benefit of avoiding unnecessary energy consumption and provides an additional level of safety for the elderly and/or debilitated when using electrical appliances in the home.

### BRIEF SUMMARY OF THE INVENTION

This invention relates to a pre-set digital timer and plug adapter that is design to safely turn off an electrical device after the time limit on a Light Emitting Diode (LED) display has elapsed. The device has an On-Off switch that activates the LED timer when the switch is depressed and allows electrical current to flow to a device plugged into the adapter receptacle. When the time on the LED display has elapsed, the switch releases outward to the off position and disconnects the electrical current to the plugged-in device. In addition, the adapter has a down-arrow shaped selector button that allows the operator to select a shorter time period than the time currently displayed on the timer.

### BRIEF DESCRIPTION OF THE DRAWINGS OF THE INVENTION

FIG. 1 is a perspective view of the pre-set timer and plug adapter design;

FIG. 2 is a front plan view of the timer and plug adapter thereof;

FIG. 3 is a rear plan view of the timer and plug adapter thereof;

FIG. 4 is a right side plan view of the timer and plug adapter thereof;

FIG. 5 is a bottom plan view of the timer and plug adapter thereof; and,

FIG. 6 is an exploded view of the timer and plug adapter.

### DETAILED DESCRIPTION OF THE INVENTION

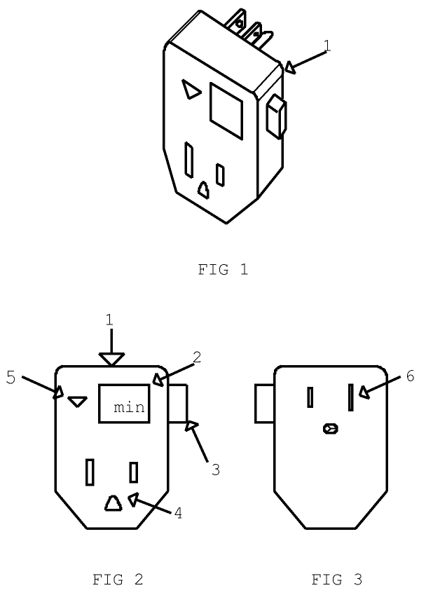

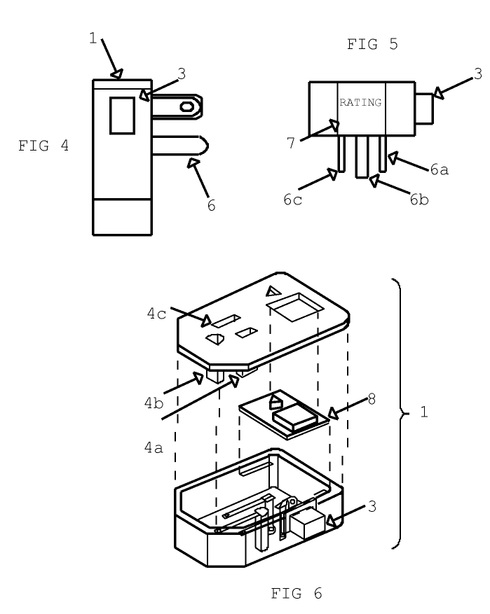

Referring to FIG. 1, item number 1, the pre-set timer and plug adapter is a device that plugs into an electrical outlet. The adapter is made of electrically insulating material and contains a LED display on the front of the device as shown in FIG. 2, item no 2. The LED display shows the time in minutes and is turned on by a push button switch (FIG. 2, item no 3) located on the right side of the device relative to the LED display. An electrical receptacle is located below the LED display on the front of the adapter accommodating a standard three prong electrical plug as shown in FIG. 2, item no 4. On the left side of the LED display there is a down-arrow shaped selector button (FIG. 2, item no 5) that allows the operator to select a shorter time period than is currently displayed on the timer. On the rear of the adapter is a three pronged electrical plug that plugs into a standard electrical wall outlet, as shown in FIGS. 3 and 4, item no 6. The electrical rating of the device is molded into the bottom of the adapter (FIG. 5, item no 7).

The device is comprised of a plug adapter for an electrical outlet containing a receptacle for receiving a single phase, three pronged and polarized electric plug. The plug adapter contacts allow current to flow to the device plugged into the adapter when the on-off button is pushed in, which also energizes and activates the Light Emitting Diode (LED) digital timer. Likewise, the plug contacts are de-energized when the digital timer has elapsed and the power source is disconnected from the electrical device plugged into the adapter.

What is claimed is:

1. In combination, a plug adapter formed of electrically-insulating material comprised of:
a three-pronged electrical plug, whereas the first, second, and third contact prongs (FIG. 5, items 6a, 6b and 6c) extend outward from the back (rear) of the housing, shaped and spaced relative to one another to engage the first, second, and third receptacle contacts of a standard electrical outlet box;
an electrical receptacle, whereas the fourth, fifth and sixth contact members (FIG. 6, items 4a, 4b and 4c) are located on the front of the adapter below the level of the rear plug and spaced relative to one another to receive a standard single phase, three prong, polarized electric plug;
the contact members shown in FIG. 6 include a first contact member (4a) connected internally to the positive plug prong (FIG. 5, item 6a) to engage the energized line of a power source;
a second contact member (4b) connected internally to the ground prong (FIG. 5, item 6b) which engages the ground line of the power system;
and a third contact member (4c) connected in series to the on-off push switch (FIG. 6, item no 3) and the neutral receptacle prong (FIG. 5, item 6c) and engaging the neutral line of the power source.

2. A LED digital timer with a maximum time period pre-set by the manufacturer and displayed in minutes (FIG. 6, item 8) located above the receptacle on the front side of the device.

3. An On-Off push button switch (FIG. 2, item 3) on the right side of the adapter relative to the LED display and at the same level as the display, which energizes the LED timer when pushed in and returns to the original position when the timer elapses, disconnecting power to the device plugged into the adapter.

4. A down-arrow shaped button mounted on a circuit board (FIG. 6, item 8) to the left of the digital timer which allows the operator to reduce the time to a shorter time period than what is currently displayed.
